(19) United States
(12) Patent Application Publication
(10) Pub. No.: US 2016/0284489 A1
(43) Pub. Date: Sep. 29, 2016

(54) Ultra-Thin Self-Balancing Flexible Key Switch for a Keyboard

(71) Applicant: Shakoor Siddeeq, Indianapolis, IN (US)

(72) Inventor: Shakoor Siddeeq, Indianapolis, IN (US)

(73) Assignee: SHAKNEL TECHNOLOGIES, LLC, Indianapolis, IN (US)

(21) Appl. No.: 14/664,919

(22) Filed: Mar. 23, 2015

(51) Int. Cl. H01H 13/14

(52) U.S. Cl. CPC H01H 13/14

(57) ABSTRACT

An ultra-thin self-balancing flexible key switch for use in portable and or mobile low profile keyboards and or keypads. The key switch disclosed uses a minimal amount of components by utilizing a thin flexible polymer strip for each row of a keyboard as opposed to using separate individual keys.

### CROSS-REFERENCE TO RELATED APPLICATIONS

The present patent application claims priority to the previously filed provisional patent application entitled “Ultra-Thin Self-Balancing Flexible Key Switch for a Keyboard” filed on Mar. 23, 2014, and assigned application No. 61/969,209 which is hereby incorporated by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention generally relates to a key switch of a keyboard, such as a laptop computer keyboard or tablet computer keyboard, and more specifically relates to ultra-thin and flexible key switches with high key travel used in low profile portable and or mobile keyboards.

2. Description of Related Art

Portable and or mobile keyboards, such as laptop and or tablet computer keyboards, typically utilize low profile thin key switches to decrease overall keyboard thickness. These low profile key switches act as a balancing mechanism for each key to allow for fast typing with minimal errors and great tactile feedback. Most portable or mobile keyboards utilize a thin low profile x-structure or scissor-type key switch as a balancing mechanism. The scissor-type key switch design prevents key wobble and acts to stabilize and or level a key during a key press by pulling all sides of the key down simultaneously regardless of which part of the key is pressed.

A design goal with many types of portable and or mobile keyboards has been to decrease their dimensional size or thickness and their overall volume to make them more portable, mobile, lighter, and easier to carry and store. One goal of decreasing the thickness of a portable and or mobile keyboard is to employ a relatively thin scissor-type key switch mechanism while maintaining a relatively high key travel. Key travel is the distance that a given key physically moves perpendicular to the keyboard when depressed by a user. For low profile portable and or mobile keyboards key travel is typically in the range of 1.5 mm to 3.5 mm. A low profile keyboard using a scissor-type key switch balancing mechanism with key travel of 3.5 mm is generally regarded to have better tactile feedback and typing response and feel than one with only 1.5 mm key travel. Relatively high key travel permits a portable or mobile keyboard to mimic the tactile feel of a standalone desktop computer keyboard commonly attached to desktop computers which typically have a key travel distance of 4.0 mm.

One difficulty in maintaining relatively high key travel with relatively thin portable or mobile keyboards is that as the key travel distance is increased the keys become more prone to wobble or tilt. Wobble and tilt are undesirable, as they qualitatively degrade the user experience of typing on the keyboard. As such, users are not as likely to enjoy typing on the keyboard, and the users are likely to not be able to type as quickly on the keyboard as compared to standalone desktop computer keyboards.

As previously mentioned, one way to minimize wobble and tilt is to employ a rigid scissor-type key switch arrangement, which permits balanced key travel during key presses. However, scissor-type key switches are manufactured using a number of separate pieces per key on a keyboard via injection-molding techniques, and thereafter require complex assembly of the multiple parts for each key.

Additionally, scissor-type key switches are rigid, which prevents the keyboard from being flexible, and also add an extra thickness requirement to the keys of the keyboard. This extra thickness requirement is due to the need to have protruding snap-in connectors underneath each key and at the base of each key. These protruding connectors enable the scissor-type key switch to connect to the underside of the key and the top side of the base to prevent slippage during a key press.

However, these protruding rigid connectors in the scissor-type key switch prevent flexibility and add both complexity and cost to both the manufacturing and assembly and more importantly add undesirable extra thickness to each key. This lack of flexibility and extra thickness inherent in the design of the scissor-type key switch result in portable and or mobile keyboards that are too rigid and too thick.

Prior art, such as that disclosed by Kessler et al. in U.S. Pat. No. 8,592,699 disclose thin profile self-balancing key switches as alternatives to the scissor-type key switch but are not flexible and contain multiple pieces, making it complex to assemble. In U.S. Pat. No. 6,911,608, Levy discloses a stretched flexible keypad under tension. However, the keypad disclosed by Levy fails to isolate the tension about the perimeter of each key and instead incorporates the tension across the entire keypad. As a result, when one key is pressed, surrounding keys may also accidentally become depressed. This is due to the tension present across the entire keypad acting in conjunction with the applied downward force of the adjacent key pressed. To offset this Levy incorporates elevated convex and suppressed concave regions to prevent adjacent key interference. However, such incorporated regions add thickness to the keypad, making the keypad flexible but not thin. Additionally, Levy fails to incorporate a downward component of tension about each key, which is critical for a more responsive and dynamically self-balancing key switch mechanism.

In U.S. Pat. No. 8,129,645, Siddeeq discloses a dynamically self-stabilizing elastic key switch. This dynamically self-stabilizing key switch successfully levels a key during a key press by incorporating downward tension about the perimeter of each key in its unactuated state. However, it raises the center of gravity of the key by introducing a convex protrusion on the underside of each key which increases the thickness and limits the flexibility. Said invention is an improvement over the key switch disclosed in U.S. Pat. No. 8,129,645. Said invention dynamically balances each key by incorporating downward tension about the perimeter of each key in its unactuated state without raising the center of gravity or increasing the thickness. Furthermore, said invention decrease components and assembly time by utilizing the edges of the bistable base and the polymer rectangular strip as a rigid perimeter for each key.

### BRIEF SUMMARY OF THE INVENTION

The invention is an ultra-thin self-balancing flexible key switch for use in portable and or mobile low profile keyboards and or keypads. Said invention is advantageous over prior art in that it is both thin and flexible and uses a minimal amount of components by utilizing an ultra-thin, flat, and single flexible polymer rectangular strip for each row of the keyboard as opposed to using separate individual keys.

### BRIEF DESCRIPTION OF THE SEVERAL VIEWS OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 depicts a cross-sectional side view of the ultra-thin self-balancing flexible key switch (UTSBFK) in its unactuated state showing the elastic cover 1, elastic band 2, flexible polymer 3, bistable base 4, flexible pcb 5, and switch actuator 6. The elastic band 2 is slightly stretched and in a state of tension in the unactuated state. T1 and T2 represent the tension in the elastic band 2 while the UTSBFK is in its unactuated state. T1 and T2 are equal. F2 represents the resultant downward force from the tension of T1 and T2 while the UTSBFK is in its unactuated state. F1 represents the opposing force of the switch actuator 6 to the force F2. In the unactuated state, F2 is less than or equal to F1.

FIG. 2 depicts a cross-sectional side view of the ultra-thin self-balancing flexible key switch in its actuated state (during a key press) showing the elastic cover 1, elastic band 2, flexible polymer 3, bistable base 4, flexible pcb 5, and switch actuator 6. In the actuated state, the user presses downward and applies an external force to the top of the UTSBFK. In the actuated state the tension in the elastic band 2 decreases as it goes downward. Additionally, in the actuated state, the switch actuator 6 collapses downward and makes full contact with the flexible pcb 5. T3 and T4 represent the tension in the elastic band 2 while the UTSBFK is in its actuated state during a key press shown by the external applied downward force F3. T3 and T4 are equal. T3 is less than T1. F3 is greater than F1.

FIG. 3 depicts a cross-sectional side view of multiple ultra-thin self-balancing flexible key switches showing an external applied downward force F3 applied by a finger 7 depressing one UTSBFK into its actuated state.

FIG. 4 depicts a cross-sectional front view of multiple ultra-thin self-balancing flexible key switches showing an external applied downward force F3 applied by a finger 7 depressing one UTSBFK into its actuated state showing the elastic cover 1, elastic band 2, flexible polymer 3, bistable base 4, flexible pcb 5, and switch actuator 6 from a cross-sectional and or front view. Please note, for clarity, the part of the bistable base 4 that curves upward is not shown. Please note also, the elastic band 2 is shown simply as a front view fully intact while the other aspects are shown as a cross-sectional front view.

FIG. 5 depicts a cross-sectional front view of a subset of a row of ultra-thin self-balancing flexible key switches in its compressed and rolled up state with the elastic cover 1 removed. Please note, the elastic band 2 is shown as a front view fully intact while the other aspects are shown as a cross-sectional front view. In the rolled up state, the cross-sectional width curvature of the bistable base 4 becomes flat and or compressed and lengthwise it becomes flexible and curved.

FIG. 6 depicts a cross-sectional side view of the ultra-thin self-balancing flexible key switch in its compressed and rolled up state.

FIG. 7 depicts a top view of a subset of a row of ultra-thin self-balancing flexible key switches in the unactuated state with the elastic cover 1 removed.

FIG. 8 depicts a top view of a subset of a row of ultra-thin self-balancing flexible key switches in the unactuated state with the elastic cover 1 visible showing the printed characters of a subset of the keys.

### DETAILED DESCRIPTION OF THE INVENTION

The invention is an ultra-thin self-balancing flexible key switch (UTSBFK) for use in portable and or mobile low profile keyboards and or keypads. Aspects of said invention described below are described in its preferred embodiment.

In its preferred embodiment, the ultra-thin self-balancing flexible key switch (UTSBFK) is composed of an elastic cover 1, two or more elastic bands 2, a single strip of a flexible polymer 3, a single bistable base 4, one or more layers of a flexible pcb 5, and a single switch actuator 6 for each key character.

The elastic cover 1 of the UTSBFK protects the UTSBFK from external elements and may be composed of a thin layer or sheet of silicone rubber. The elastic cover 1 may fully enclose a single row of UTSBFKs and may be attached via adhesive and or tape to parts of the bottom side of the bistable base 4 and parts of the top side of the flexible polymer. Additionally, multiple rows of UTSBFKs may be adhered together to form an entire keyboard.

The elastic cover 1 may be totally flat or contain slight geometrical indentions and or slightly raised geometrical features to delineate individual keys. The top of the elastic cover 1 shall contain the printed characters for each key and each individual key shall correspond to an individual switch actuator 6 located beneath the flexible polymer 3.

The elastic band 2 may be composed of a rubber material that is thin in width and thickness, similar to a typical rubber band, but much thinner.

The flexible polymer 3 may be composed of a thin polymer strip such as 0.25 mm thick polycarbonate and have a width of at least 12 mm and length of at least the entire length of the row of the keyboard of which it is incorporated.

The bistable base 4 may be composed of a metal such as steel and have a thickness of 0.2 mm or less, a width of at least 15 mm but not greater than 19.05 mm (in its uncompressed state), and a length slightly greater than the length of the flexible polymer 3. Its bend radius of curvature (widthwise) about an imaginary center point (not on its structure) in its uncompressed state should not be greater than 15 mm. Its bend radius of curvature (lengthwise) about an imaginary center point (not on its structure) in its compressed rolled up state should not be greater than 15 mm.

The flexible pcb 5 may be composed of any material typically used for flexible circuits in keyboards, such as polyester and the traces on the circuit may be printed using typical conductive inks such as carbon or silver. The flexible pcb 5 may contain multiple layers to accommodate multiple columns parallel and perpendicular to a single row.

The switch actuator 6 may be composed of silicone rubber and its design may be that of any typical rubber dome switch actuator used in laptop computer keyboards. It may contain a carbon pill or it may not, depending on the design of the circuit traces of the flexible pcb 5.

In its preferred embodiment, the ultra-thin self-balancing flexible key switch (UTSBFK) is assembled as described below.

The flexible pcb 5 is aligned and affixed (via adhesive and or tape) to part(s) of the top side of the bistable base 4. The switch actuator 6 is aligned and affixed (via adhesive and or tape) to part(s) of the top sides of the flexible pcb 5 and bistable base 4. A rectangular thin strip of the flexible polymer 3 is aligned (but not affixed) and set on top of the switch actuator(s) 6. With the flexible polymer 3 held in place, a pair of elastic bands 2 are stretched and slipped over the entire assembly so that they fully enclose and or sandwich the bistable base 4, flexible pcb 5, switch actuator(s) 6, and the strip of flexible polymer 3. The elastic bands 2 are centrally spaced at intervals corresponding to the left and or right edges of each character key in a row of keys where the center of each key is represented by the location and center of each switch actuator 6. The elastic cover 1 sleeve, open on one end, is slightly stretched (width wise) and slipped over the entire assembly of the bistable base 4, flexible pcb 5, switch actuator(s) 6, flexible polymer 3, and elastic bands 2. Tape and or adhesive on part(s) of the bistable base 4 and flexible polymer 3 help keep the elastic cover 1 from slipping. The open end of the elastic cover 1 allows each row of UTSBFKs to connect structurally (via the bistable base 4) and electronically (via the flexible pcb 5) to the main keyboard parts, such as the power supply, micro-processor unit, electronics, and the main structural enclosure, none of which are described here. Once the bistable base 4 and flexible pcb 5 are attached to the main keyboard parts, the open end of the elastic cover 1 may be sealed and attached to the main keyboard parts as well.

While the UTSBFK is in its unactuated state (i.e. no key has been pressed), the pair of elastic bands 2 are stretched and wrapped around the bistable base 4 and all the components sitting atop the bistable base 4. The pair of elastic bands 2 are spaced apart based on the desired length of each key and placed equidistant and on either side of the central vertical axis of each switch actuator 6 so that there is one elastic band to the left and one elastic band to the right of each switch actuator 6. The pair of elastic bands 2 are attached to the rigid parallel edges of the bistable base 4. The rigid parallel edges of the bistable base 4 are disposed at a vertical distance below the switch actuator 6 and the flexible polymer 3 such that a height differential is created. This height differential keeps the pair of elastic bands 2 in a stretched state.

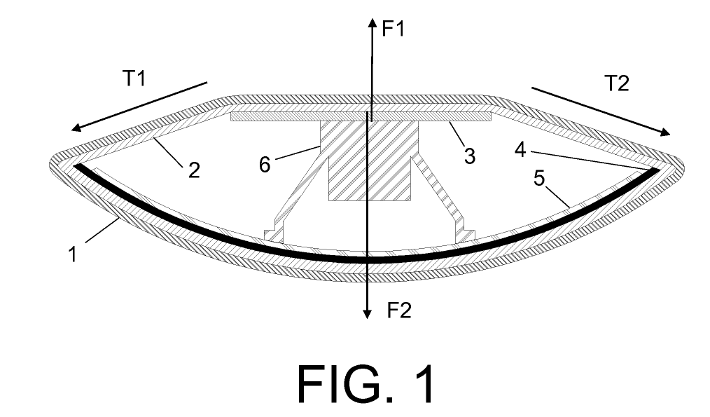

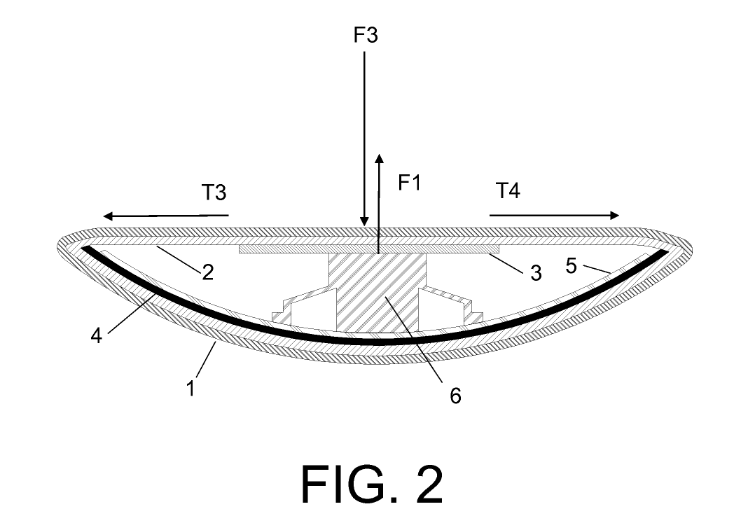

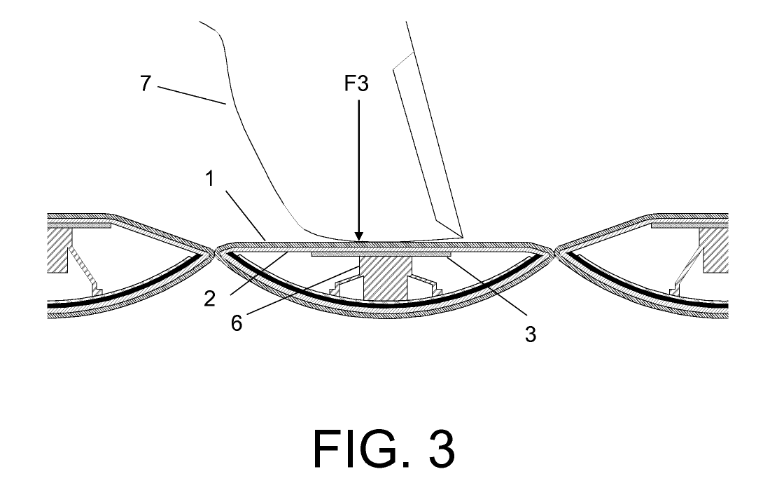

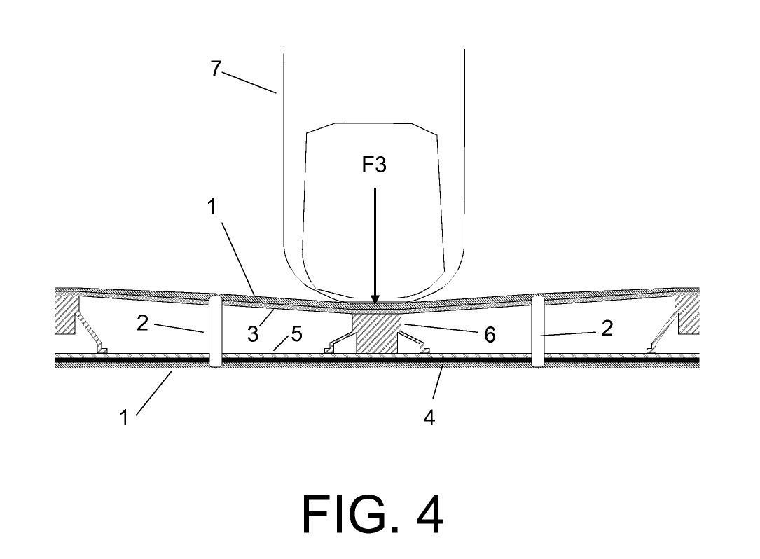

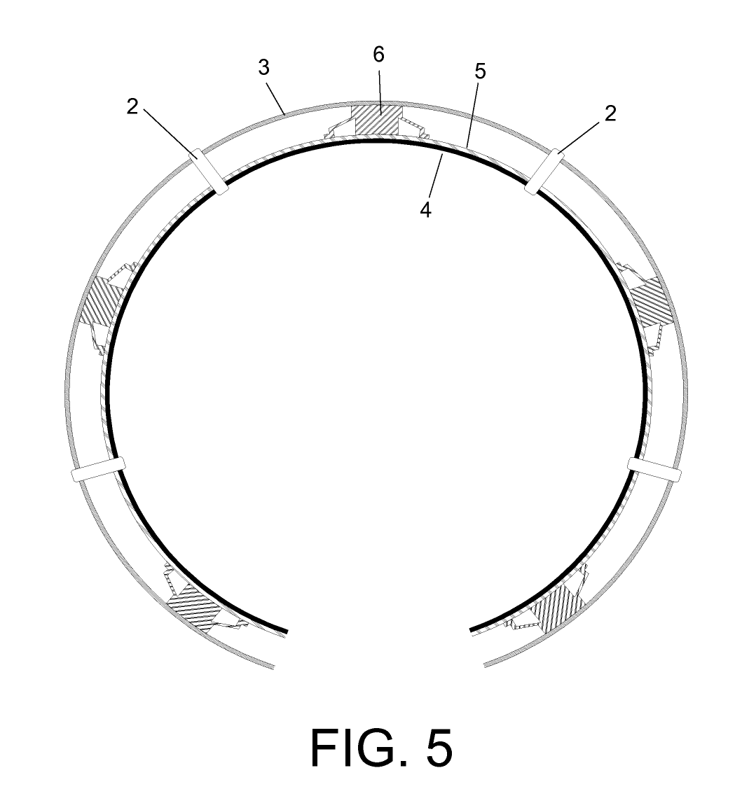

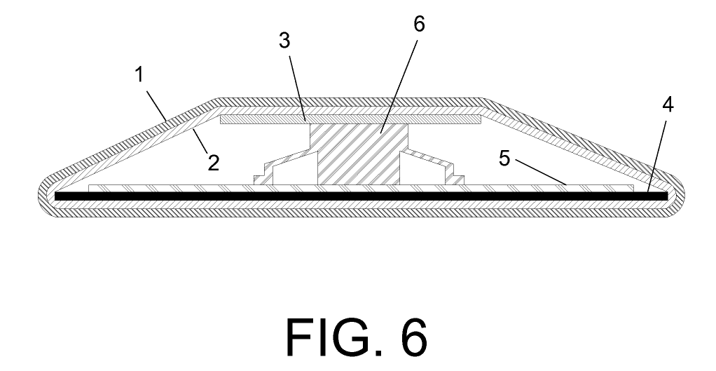

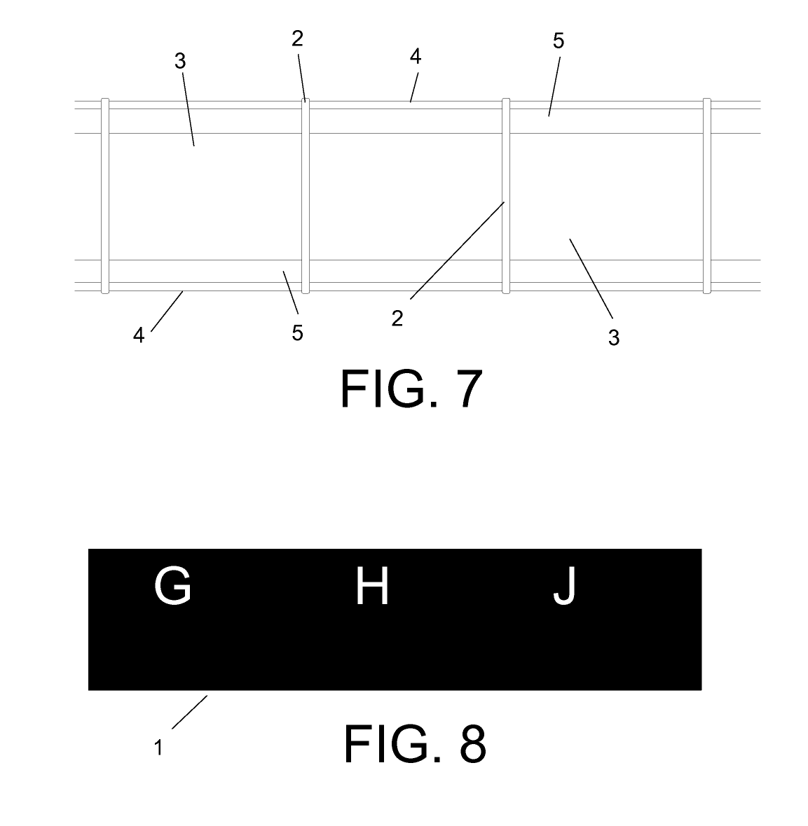

The stretching in the elastic band 2 creates a slight tension in the elastic band 2. FIG. 1 depicts this tension as T1 and T2. The tension T1 and T2 in the pair of elastic bands 2 creates a net downward force component, resultant downward force F2, through the vertical central axis of the switch actuator 6. The switch actuator 6 produces a counter balancing, net opposing force F1, or upward force component. The net resultant opposing force F1 goes through the vertical central axis of the switch actuator 6. The upward force component F1 and the downward force component F2 create a self-balancing state of rotational mechanical equilibrium such that any downward external force, F3 (key press or actuation of the switch actuator), applied at any point between any pair of elastic bands on a top surface of the flexible polymer 3 (or the elastic cover 1 directly above it), is dynamically transferred towards the vertical central axis of the switch actuator 6.

It should be noted by those skilled in the art that the invention has been described with reference to a number of embodiments. The number, materials, operating mechanisms, properties, sizes, shapes, types, and other characteristics of the components that are not depicted or described are trivial and numerous variations of these exist which may be used to construct the device without changing the spirit and scope of the invention. As such, it is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of embodiments of the present invention. Therefore, it is manifestly intended that this invention be limited only by the claims and equivalents thereof.

What I claim as my invention is:

1: An ultra-thin self-balancing flexible key switch is claimed that comprises:
A pair of elastic bands, a flexible polymer, a bistable base, a flexible pcb, a switch actuator; whereas in an unactuated state:
The flexible pcb is attached to and set atop the bistable base; whereas the switch actuator is attached to and set atop the flexible pcb; whereas the flexible polymer is set atop the switch actuator; whereas
the pair of elastic bands are stretched and wrapped around the bistable base, the flexible pcb, the switch actuator, and the flexible polymer; whereas the pair of elastic bands are spaced apart and placed equidistant and on either side of a vertical central axis of the switch actuator; whereas
the pair of elastic bands are attached to rigid parallel edges of the bistable base;
whereas the rigid parallel edges of the bistable base are disposed at a vertical distance below the flexible polymer such that a height differential is created;
whereas the height differential retains the stretching of the pair of elastic bands;
whereas the stretching in the pair of elastic bands create a slight tension in the pair of elastic bands; whereas
the slight tension in the pair of the elastic bands creates a downward force component about the flexible polymer; whereas
the switch actuator produces a counter balancing upward force component against the flexible polymer; whereas
the upward force component and the downward force component maintain a self-balancing state of rotational mechanical equilibrium; such that
any downward external force applied at any point between the pair of elastic bands on a top surface of the flexible polymer is dynamically transferred towards the vertical central axis of the switch actuator.
